(19) United States
(12) Patent Application Publication
(10) Pub. No.: US 2013/0278717 A1
(43) Pub. Date: Oct. 24, 2013

(54) STEREOSCOPIC MOVING PICTURE GENERATING APPARATUS AND STEREOSCOPIC MOVING PICTURE GENERATING METHOD

(71) Applicant: FUJITSU LIMITED, Kawasaki-shi (JP)

(72) Inventor: Toshiro OHBITSU, Akishima (JP)

(21) Appl. No.: 13/917,530

(22) Filed: Jun. 13, 2013

Related U.S. Application Data
(63) Continuation of application No. PCT/JP2010/072814, filed on Dec. 17, 2010.

(51) Int. Cl. H04N 13/00

(52) U.S. Cl. CPC H04N 13/0007
USPC 348/42

(57) ABSTRACT

An apparatus comprises a storage unit to get stored with a first and a second dynamic image, a predetermined image and a predetermined value; and an arithmetic unit to calculate a first difference quantity defined as a difference between a first position defined as an existing position of the predetermined image in the first image and a second position defined as an existing position of the predetermined image in the second image; to calculate a second difference quantity defined as a difference between a third position defined as an existing position of the predetermined image in the third image and a fourth position defined as an existing position of the predetermined image in the fourth image; and to generate, when a magnitude of the second difference quantity is larger than the predetermined value, a new fourth image based on the second image, the third image and the first difference quantity.

### CROSS-REFERENCE TO RELATED APPLICATION

This is a continuation of application, filed under 35 U.S.C. §111(a) of International Application PCT/JP2010/072814, filed on Dec. 17, 2010, the contents of which are herein wholly incorporated by reference.

### FIELD

The present invention relates to a stereoscopic moving picture generating apparatus and a moving picture generating method.

### BACKGROUND

There is a moving picture generating apparatus for generating images that can be stereoscopically viewed by making use of a parallax between the images captured by two cameras adjacent to each other. The moving picture generating apparatus generates and displays the image captured by one camera as an image for a left eye and the image captured by the other camera as an image for a right eye in the images captured by the two adjacent cameras, thereby making a viewer perceive the stereoscopic image.

With respect to the same physical object, a difference between a position in the image for the left eye and a position in the image for the right eye is referred to as a parallax. When parallax quantities are different between two physical objects existing within the image (picture), one physical object appears to exist nearer or farther than the other physical object. The parallax quantity is defined as a magnitude of the parallax.

FIG. 1 is a diagram illustrating an example of the stereoscopic picture. In FIG. 1, an image 910 is an image for a left eye, and an image 920 is an image for a right eye. Herein, an object A, an object B and an object C exist in each of the image 910 as the image for the left eye and the image 920 as the image for the right eye. Due to parallaxes of these objects between the image 910 and the image 920, a person looking at the stereoscopic picture in FIG. 1 views the object A, the object B and the object C as if existing in this sequence from the near side.

### DOCUMENTS OF PRIOR ARTS

### Patent Document

[Patent document 1] International Publication WO2004/043079
[Patent document 2] Japanese Patent Application Laid-Open Publication No. 2008-92555
[Patent document 2] Japanese Patent Application Laid-Open Publication No. 2009-135686
[Patent document 3] Japanese Patent Application Laid-Open Publication No. 2008-160382

### SUMMARY

On the occasion of viewing moving picture (dynamic image), a target object (an object, a physical object) in motion is often focused. There is a case in which a parallax quantity of the target object in motion increases due to abnormality etc when reproducing or generating (recording) the moving picture. At this time, it might happen that a user who views the stereoscopic moving picture is unable to recognize the target object with the large parallax quantity as the same target object in a dynamic image for a right eye and in a dynamic image for a left eye.

According to one aspect of the disclosure, a stereoscopic moving picture generating apparatus includes:

a storage unit to get stored with a first dynamic image containing a plurality of images associated with respective items of timing information, a second dynamic image containing the plurality of images associated with the respective items of timing information, a predetermined image and a predetermined value; and

an arithmetic unit: to calculate a first difference quantity defined as a difference between a first position and a second position by extracting a first image of the first dynamic image and a second image of the second dynamic image which are associated with first timing information and the predetermined image from the storage unit, calculating the first position defined as an existing position of the predetermined image in the first image and calculating the second position defined as an existing position of the predetermined image in the second image; to calculate a second difference quantity defined as a difference between a third position and a fourth position by extracting a third image of the first dynamic image and a fourth image of the second dynamic image which are associated with second timing information defined as a timing next to the first timing information with respect to the first dynamic image and the predetermined value from the storage unit, calculating the third position defined as an existing position of the predetermined image in the third image and calculating the fourth position defined as an existing position of the predetermined image in the fourth image; and to generate, when a magnitude of the second difference quantity is equal to or larger than the predetermined value, a new fourth image on the basis of the second image, the third image and the first difference quantity.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating an example of a stereoscopic picture.

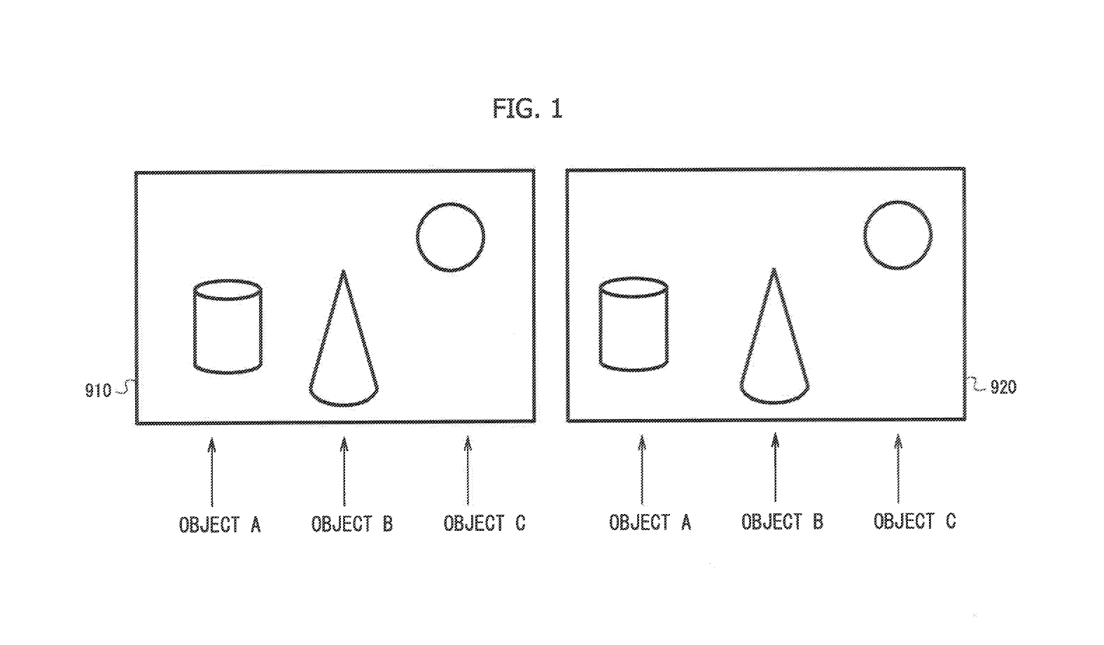

FIG. 2 is an explanatory diagram of a parallax in the stereoscopic picture.

FIG. 3 is a diagram illustrating an example of a structure of MPEG-2 formatted data.

FIG. 4 is a diagram illustrating a relationship between an I-picture, a P-picture and a B-picture.

FIG. 5 is a diagram illustrating an example of a stereoscopic moving picture generating apparatus.

FIG. 6 is a diagram illustrating an example of a hardware configuration of an information processing apparatus.

FIG. 7 is a flowchart depicting an example (1) of an operation flow of the stereoscopic moving picture generating apparatus.

FIG. 8 is a flowchart depicting an example (2) of the operation flow of the stereoscopic moving picture generating apparatus.

FIG. 9 is a flowchart depicting an example (3) of the operation flow of the stereoscopic moving picture generating apparatus.

FIG. 10 is an explanatory diagram of a process in step S108.

### DESCRIPTION OF EMBODIMENTS

Embodiments will hereinafter be described with reference to the drawings. Configurations of the embodiments are exemplifications, and the present invention is not limited to the configurations of the embodiments of the disclosure.

Herein, the discussion is made by using a stereoscopic moving picture based on images captured by two adjacent cameras, however, the stereoscopic moving picture is not limited to this type of images but may be based on two frames of artificially generated dynamic images, and so on.

### First Embodiment

(Parallax)

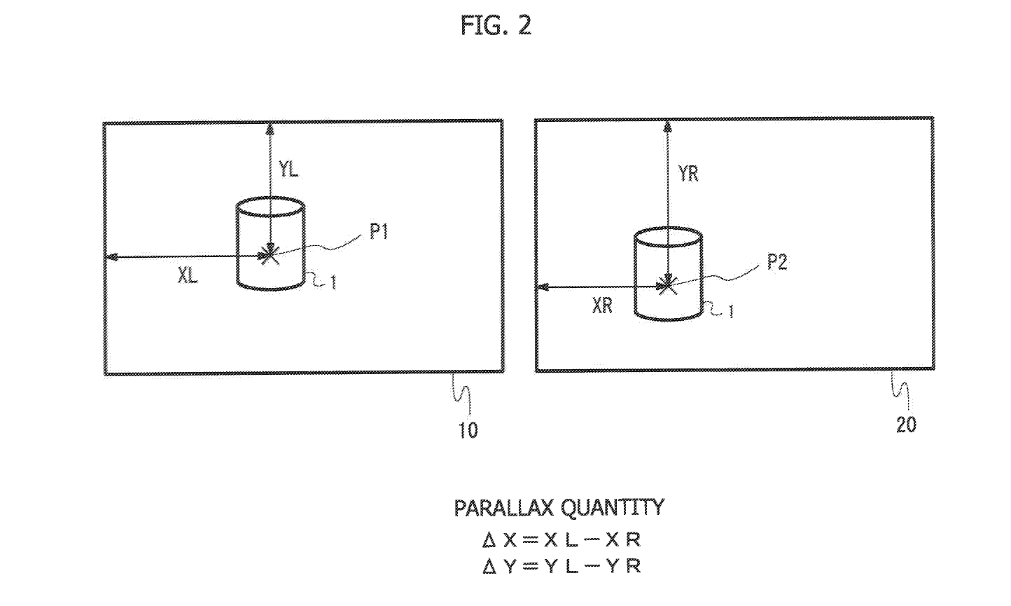

FIG. 2 is an explanatory diagram illustrating a parallax in the stereoscopic moving picture. In FIG. 2, for instance, in images of the same physical object captured by the two adjacent cameras, an image 10 is defined as an image for a left eye, while an image 20 is defined as an image for a right eye. In the example of FIG. 2, the image 10 and the image 20 contain an object 1 defined as the same physical object. Herein, a point P1 is set as a point representative of a position of the object 1 in the image 10. A point P2 is set as a point representative of a position of the object 1 in the image 20. The point representative of the position of the object 1 may be set to, e.g., a central point of the object 1 and also a point located at a rightward lower edge of the object 1. The point representative of the position of the object 1 is not limited to these points. The point P1 and the point P2 are points each indicating the same position of the object 1. The point P1 and the point P2 are also referred to as the position of the object 1 in the image 10 and as the position of the object 1 in the image 20, respectively.

The parallax in the stereoscopic moving picture is a difference between the position in the image for the left eye and the position in the image for the right eye with respect to the same physical object. A parallax quantity is a magnitude of the parallax.

In the image 10 and the image 20 of FIG. 2, the parallax quantity of the object 1 is a difference between the position (point P1) of the object 1 in the image 10 and the position (point P2) of the object 1 in the image 20. To be specific, let (XL, YL) be a coordinate of the point P1 in the image 10 and (XR, YR) be a coordinate of the point P2 in the image 20, and the parallax quantity of the object 1 is expressed as follows.

ΔX=XL−XR

ΔY=YL−YR [Mathematical Expression 1]

Herein, ΔX represents the parallax quantity in a crosswise direction, and ΔY denotes the parallax quantity in a lengthwise direction.

For example, the parallax of the object 1 in the stereoscopic moving picture disappears by moving the image for the right eye in parallel to a degree corresponding to this parallax quantity.

(Example of Data Structure)

<MPEG2>

Herein, an MPEG-2 (Moving Pictures Expert Group 2) format will be described.

According to the MPEG-2 format, the moving picture contains a plurality of images (static images) having time information. This moving picture is reproduced in a time sequence of the time information. Respective pieces of image data in the MPEG-2 format are compressed at intervals of a predetermined image data count (a predetermined number of frames).

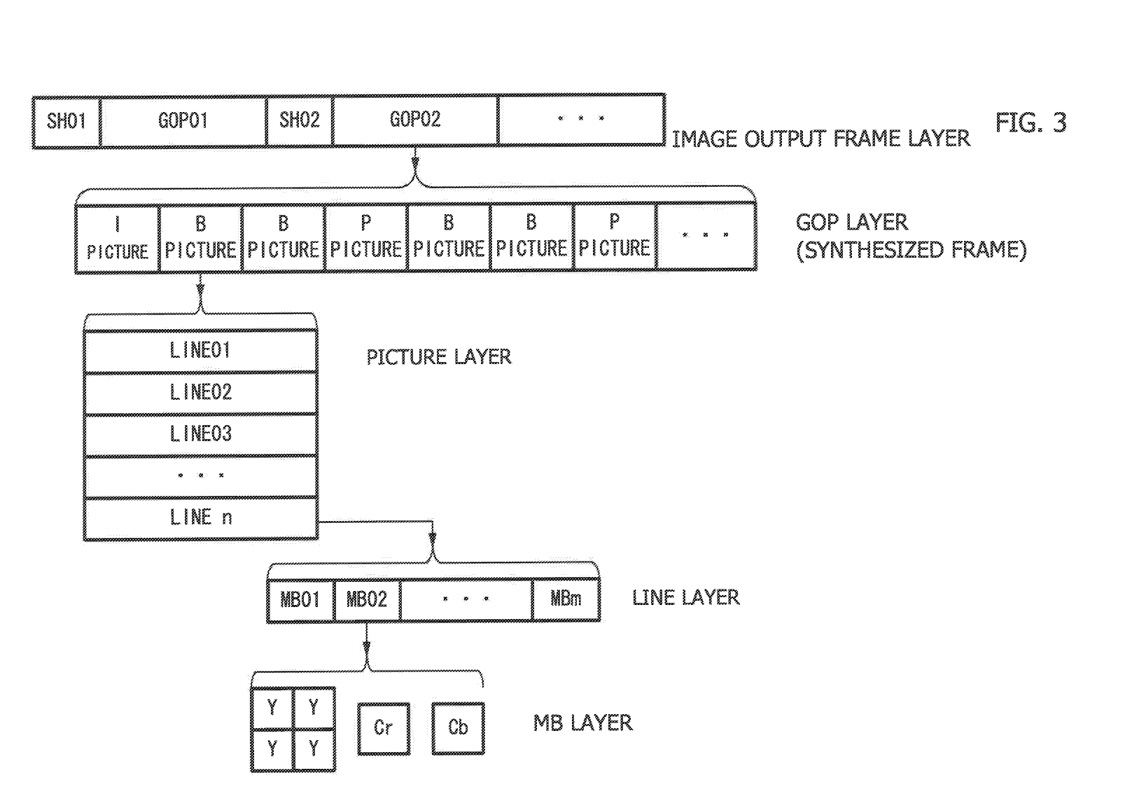

FIG. 3 is a diagram illustrating an example of a structure of MPEG-2 formatted data. The MPEG-2 formatted data in FIG. 3 takes a hierarchical structure. The MPEG-2 formatted data in FIG. 3 contains an image output frame layer, a GOP (Group of Pictures) layer, a picture layer, a line layer and an MB (Micro Block) layer.

The image output frame layer is the MPEG-2 formatted data corresponding to one video (one video sequence). The image frame layer contains a GOP (Group of Pictures) and an SH (Sequence Header). The image output frame layer contains a plurality of GOPs and a plurality of SHs.

The GOP is an aggregation of frames (pictures) needed for managing the frames efficiently. The frame is the minimum unit editable in the data of the moving pictures. The SH contains information such as a start point of the pictures of the GOP. The SH contains also time information and a frame rate.

The GOP layer includes an I-picture (Intra-coded picture) that is solely reproducible, a P-picture (Predicted picture) that is reproduced by use of the previous I-picture or P-picture, and a B-picture (Bi-directional Predicted picture) that is reproduced by use of the previous and forward I-picture or P-picture. The I-picture is the frame that is encoded for the first time. Decoding is started from the I-picture.

The picture layer includes a plurality of line blocks. In the example of FIG. 3, the picture layer includes n-pieces of line blocks. The number of the line blocks included in the picture layer depends on a size of the picture.

The line layer includes a plurality of macro blocks (MBs). The macro block contains luminance information (Y-information) and chrominance information (Cr information, Cb information).

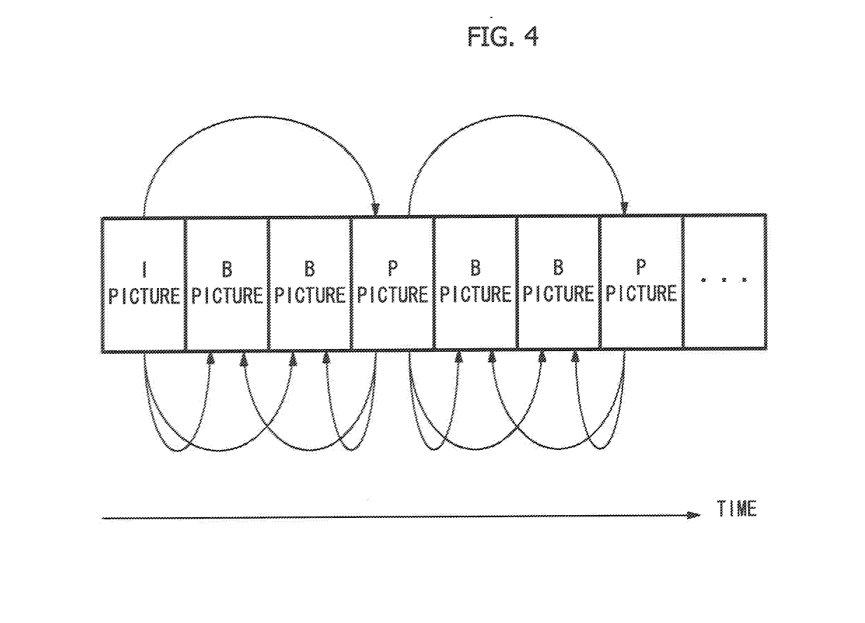

FIG. 4 is a diagram illustrating a relationship between, the I-picture, the P-picture and the B-picture. In the example of FIG. 4, the pictures become older (more previous) in terms of time in the sequence from the left-most picture. The I-picture is solely reproducible. The P-picture is reproduced by acquiring the information from the previous I-picture or P-picture. The B-picture is reproduced by acquiring the information from the previous I-picture or P-picture and from the forward P-picture. Herein, the information represents information about an intra-picture region (e.g., the macro block) and information about motion prediction (motion vector) of this region.

The data of the I-picture contains data of a moving image and data of a non-moving image. The data of the I-picture involves distinguishing between the moving image and the non-moving image. The non-moving image implies a background etc that does not change even the picture at a forward time next to this picture. The non-moving image is an image of the region in which the motion vector is zero vector. The moving image is an image containing a moving object etc in the picture at the forward time next to this picture. The moving image is an image of the region in which the motion vector is not the zero vector. The data of the P-picture contains the data of the moving image and the data of the non-moving image. The data of the P-picture involves distinguishing between the moving image and the non-moving image. The data of the B-picture contains the data of the moving image. That is, the data of the B-picture contains the image of the region in which the motion vector is not the zero vector. The data of each picture contains the data of the moving image. If any motion does not appear in the whole image, however, the data of each picture does not contain the data of the moving image.

<AVI>

Herein, an AVI (Audio Video Interleave) format will be described.

According to the AVI format, the dynamic image contains the plurality of images (static images) having the time information. This dynamic image is reproduced in a time sequence of the time information. Each piece of image data in the AVI format is compressed on a per image data basis. The image data in the AVI format is solely reproducible as in the case of the I-picture explained earlier. Further, the image data does not involve distinguishing between the moving image and the non-moving image.

A difference between the image to be processed and the image at the time just previous to this image is taken, in which the region with the difference being “0” can be defined as the non-moving image, and the region with the difference not being “0” can be defined as the moving region (image). The difference between the timewise adjacent images is calculated beforehand, and, even when the moving image is AVI-formatted, the whole image can be separated into the moving image and the non-moving image. The moving image (region) and the non-moving image (region) may be calculated beforehand and stored in a storage unit etc.

(Configuration)

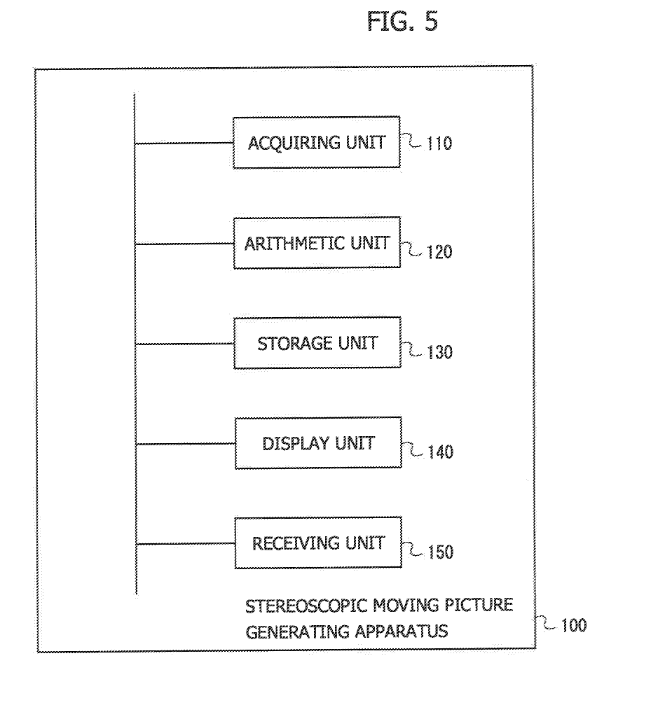

FIG. 5 is a diagram depicting an example of a stereoscopic moving picture generating apparatus. A stereoscopic moving picture generating apparatus 100 includes an acquiring unit 110, an arithmetic unit 120 and a storage unit 130.

The acquiring unit 110 acquires the dynamic images from an external or internal input device. The dynamic images acquired by the acquiring unit 110 are the dynamic image for the left eye and the dynamic image for the right eye in the stereoscopic moving picture. The dynamic images acquired by the acquiring unit 110 are stored in the storage unit 130. The dynamic image for the left eye and the dynamic image for the right eye are stored in the storage unit 130 in the way of being associated with each other. The dynamic image contains, e.g., the plurality of consecutive images (static images) attached with the time information. Each image contained in the dynamic image has a pixel value per dot within the image. The pixel value is information representing a color etc of the dot. The pixel values are expressed by, e.g., an R (Red) value, a G (Green) value and a B (Blue) value of RGB color coordinate system. As a substitute for the RGB color coordinate system, parameters (values) of other color coordinate systems (e.g., a YUV color coordinate system) may also be employed. In the case of using the parameters of the YUV color coordinate system, a Y (Yellow) value may be used as a luminance value.

The arithmetic unit 120 calculates the parallax quantity with respect to the images on a one-by-one basis, which are contained in the dynamic image acquired by the acquiring unit 110, thereby generating the stereoscopic moving picture. The stereoscopic moving picture generated by the arithmetic unit 120 is stored in the storage unit 130.

The storage unit 130 gets stored with the dynamic images acquired by the acquiring unit 110, the stereoscopic moving picture generated by the arithmetic unit 120, the parallax quantity calculated by the arithmetic unit 120, an offset quantity predetermined with respect to the stereoscopic moving picture that is about to be generated, and so on.

A display unit 140 displays the dynamic images etc stored in the storage unit 130.

A receiving unit 150 accepts an input such as a selection of the reference object from a user.

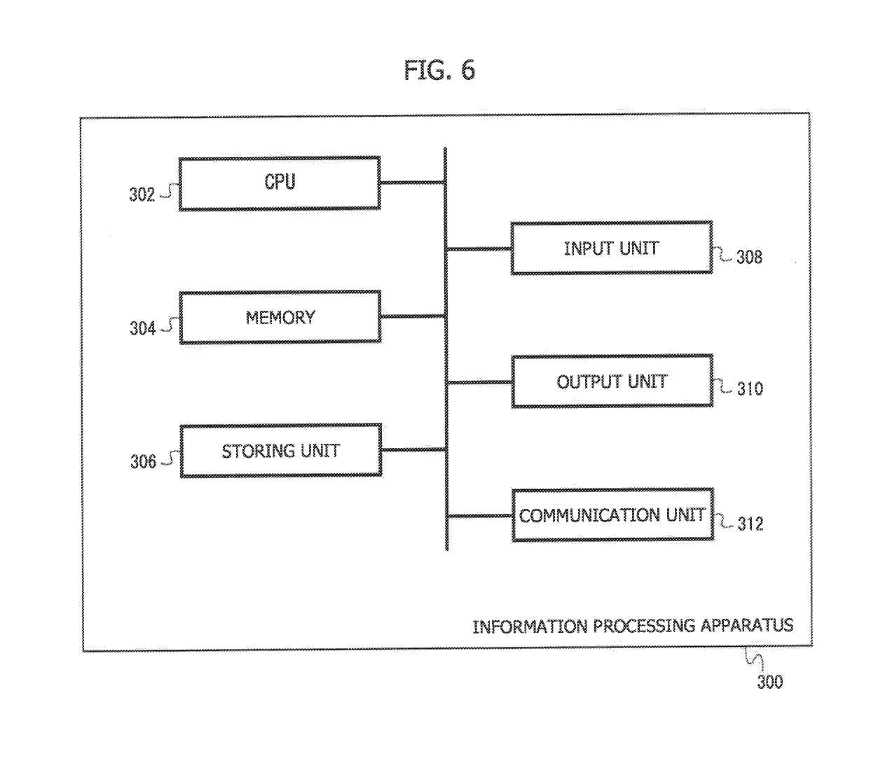

FIG. 6 is a diagram illustrating an example of a hardware configuration of an information processing apparatus 300. The stereoscopic moving picture generating apparatus 100 is realized by, e.g., the information processing apparatus 300 as depicted in FIG. 6. The information processing apparatus 300 includes a CPU (Central Processing Unit) 302, a memory 304, a storing unit 306, an input unit 308, an output unit 310 and a communication unit 312.

The CPU 302 loads a program stored in a recording unit 306 into an operation area of a memory 304 and executes this program, whereby the information processing apparatus 300 can actualize functions conforming to predetermined purposes by controlling peripheral devices through the execution of the program.

The CPU 302 performs processes according to the program stored in the storing unit 306. The memory 304 caches the program executed by the CPU 302 and the data processed by the CPU 302 and also deploys the operation area. The memory 304 includes, e.g., a RAM (Random Access Memory) and a ROM (Read Only Memory).

The storing unit 306 stores various categories of programs and various items of data on a readable/writable recording medium. The storing unit 306 is exemplified by a solid-state drive device, a hard disk drive device, a CD (Compact Disc) drive device, a DVD (Digital Versatile Disc) drive device, a +R/+RW drive device, an HD DVD (High-Definition Digital Versatile Disc) drive device or a BD (Blu-ray Disc) drive device. Furthermore, the recording medium is exemplified by a silicon disk including a nonvolatile semiconductor memory (flash memory), a hard disk, a CD, a DVD, a +R/+RW, an HD DVD or a BD. The CD is exemplified by a CD-R (Recordable), a CD-RW (Rewritable) and a CD-ROM. The DVD is exemplified by a DVD-R and a DVD-RAM (Random Access Memory). The BD is exemplified by a BD-R, a BD-RE (Rewritable) and BD-ROM.

The input unit 308 accepts an operating instruction etc from the user etc. The input unit 308 is exemplified by input devices such as a keyboard, a pointing device, a wireless remote controller, a microphone and a plurality of cameras. The CPU 302 is notified of information inputted from the input unit 308.

The output unit 310 outputs the data processed by the CPU 302 and the data stored in the memory 304. The output unit 310 is exemplified by output devices such as a CRT (Cathode Ray Tube) display, an LCD (Liquid Crystal Display, a PDP (Plasma Display Panel), an EL (Electroluminescence) panel, a printer and a loudspeaker.

The communication unit 312 transmits and receives the data to and from the external device. The communication unit 312 is connected to the external device via, e.g., a signal line. The communication unit 312 is exemplified such as a LAN (Local Area Network) interface board and a wireless communication circuit for wireless communications.

In the information processing apparatus 300, the storing unit 306 is stored with an operating system (OS), the various categories of programs and a variety of tables.

The OS is software that handles in-between operations between the software components and the hardware components, manages a memory space, manages files and manages processes and tasks. The OS includes a communication interface. The communication interface is defined as a program for transferring and receiving the data to and from the external device etc connected via the communication unit 312.

The information processing apparatus 300 capable of realizing the stereoscopic moving picture generating apparatus 100 actualizes functions as the acquiring unit 110, the arithmetic unit 120 and the receiving unit 150 in such a way that the CPU 302 loads the programs stored in the storing unit 306 into the memory 304 and executes the programs. Further, the storage unit 130 is provided in storage areas of the memory 304, the storing unit 306, etc. The display unit 140 is realized by the CPU 302, the output unit 310, etc. The receiving unit 150 is realized by the CPU 302, the input unit 308 and so on.

### Operation Example

An operation example of the stereoscopic moving picture generating apparatus 100 will be described. In the following discussion, the dynamic image for the left eye and the dynamic image for the right eye are employed, however, there is neither superiority nor inferiority between the dynamic image for the left eye and the dynamic image for the right eye, and the both are interchangeable. Similarly, the image for the left eye and the image for the right eye are used, however, there is neither superiority nor inferiority between the image for the left eye and the image for the right eye, and the both are interchangeable.

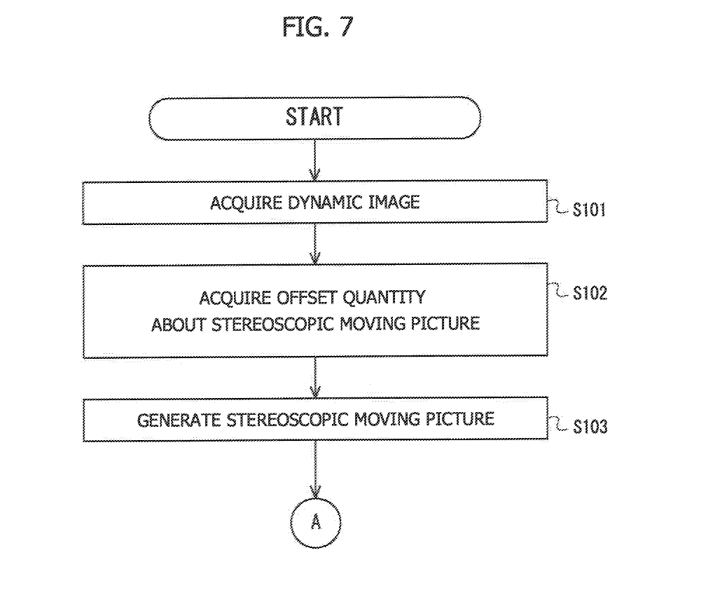

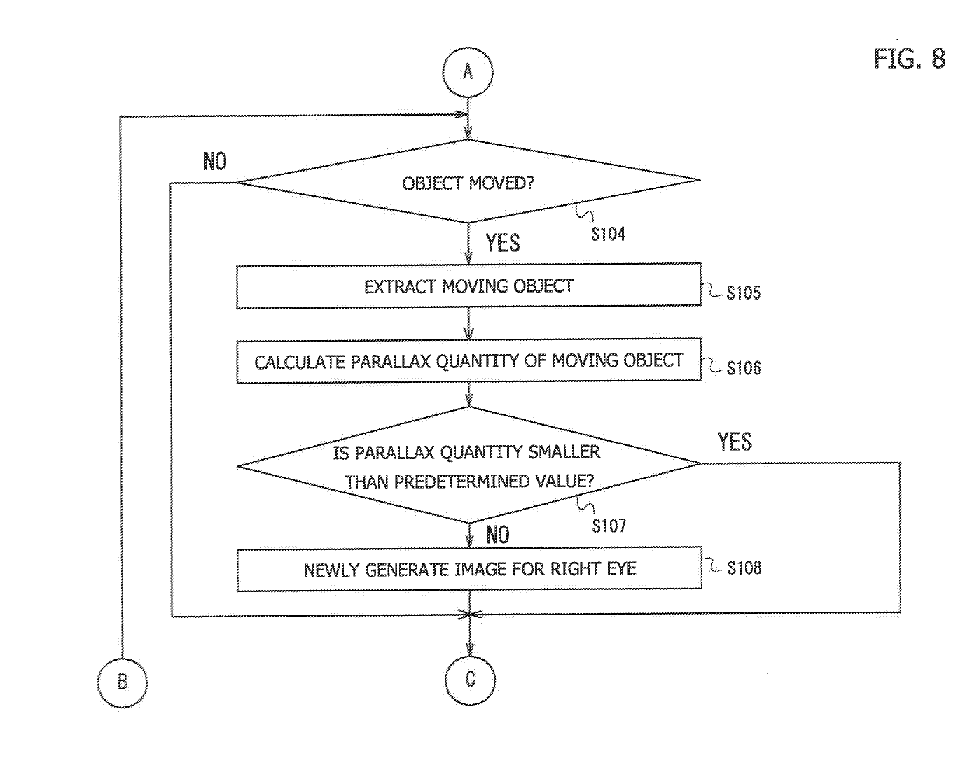

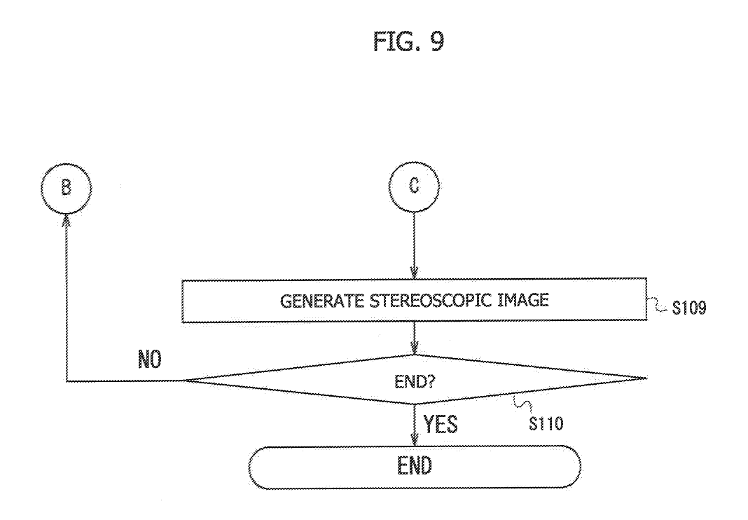

FIGS. 7, 8 and 9 are flowcharts illustrating an example of an operation flow of the stereoscopic moving picture generating apparatus 100. A symbol [A] in FIG. 7 connects to [A] in FIG. 8. Symbols [B] and [C] in FIG. 8 connect to [B] and [C] in FIG. 9. A start of the operation flow in FIG. 7 is triggered by, e.g., powering ON the stereoscopic moving picture generating apparatus 100.

The stereoscopic moving picture generating apparatus 100 acquires the dynamic image for the left eye and the dynamic image for the right eye. The stereoscopic moving picture generating apparatus 100, if there is an offset quantity predetermined with respect to the stereoscopic moving picture that is about to be generated, moves, based on this offset quantity, the whole image in parallel with respect to all of the images contained in the dynamic image (S101-S103). The dynamic image contains the plurality of consecutive static images (frames, pictures). Furthermore, the stereoscopic moving picture generating apparatus 100 calculates the parallax quantity of the moving object per static image. If the parallax quantity is not smaller than the predetermined value, the image for the right eye is generated based on, e.g., the image for the left eye etc (S104-S110). The stereoscopic moving picture generating apparatus 100 outputs the post-adjusting images as the images of the stereoscopic moving picture. The images for the left eye and the images for the right eye are reproduced normally in the timing sequence of the timing information. The dynamic images are compressed in, e.g., the MPEG-2 format. The processing of the stereoscopic moving picture generating apparatus 100 is not, however, limited to those processes.

The dynamic image for the left eye and the dynamic image for the right eye are associated with the timing information on the one-by-one basis of the image (static image) contained therein. The dynamic image for the left eye and the dynamic image for the right eye are associated with the time information in common per image contained therein. The association between the image and the time information is attained by each image having, e.g., the time information. Further, the association between the image and the time information is attained by, e.g., serial numbers given in the reproducing sequence and allocated to the respective images, the time information of the top image and a frame rate (an image count per unit time). Moreover, the association between the image and the time information is attained by, e.g., the respective images arranged in the reproducing sequence, the time information of the top image and the frame rate (the image count per unit time). Further, the time information of the top image may not be indispensable.

An in-depth description of the operation flow in FIGS. 7, 8 and 9 will be made.

The acquiring unit 110 acquires the dynamic image for the left eye and the dynamic image for the right eye (S101). The acquiring unit 110 may acquire the dynamic image for the left eye and the dynamic image for the right eye from a camera built in the stereoscopic moving picture generating apparatus 100 and may also acquire these images from the external device. The acquired dynamic image for the left eye and the acquired dynamic image for the right eye are stored in the storage unit 130. The dynamic image for the left eye and the dynamic image for the right eye may also be stored beforehand in the storage unit 130.

The arithmetic unit 120 acquires the offset quantity predetermined with respect to the stereoscopic moving picture that is about to be generated (S102). The arithmetic unit 120 extracts the offset quantity predetermined with respect to the stereoscopic moving picture that is about to be generated from, e.g., the storage unit 130. The offset quantity is defined as a quantity with which one or both of the whole dynamic images is or are moved beforehand. The parallax quantity in, e.g., the first image of the specified object within the picture can be set to “0” by determining the offset quantity. Further, for instance, the image for the left eye and the image for the right eye can be aligned in their heights by determining the offset quantity. If the offset quantity is not stored in the storage unit, the offset quantity shall be “0”. The arithmetic unit 120 prompts the user to input the offset quantity, and this inputted value may be set as the offset quantity. Herein, let ΔX0 be an offset quantity in the crosswise direction and ΔY0 be an offset quantity in the lengthwise direction.

The arithmetic unit 120 generates the stereoscopic moving picture (S103), In the process of S103, the arithmetic unit 120 takes the dynamic image for the right eye out of, e.g., the storage unit 130. Then, in the dynamic image for the right eye, the arithmetic unit 120 sets, as a new dynamic image for the right eye, the images into which the whole images are moved in parallel to a degree corresponding to the offset quantity acquired in step S102 with respect to the images at all the timings. The offset quantities (ΔX0 and ΔY0) acquired in step S102 are used as the parallax quantities. The arithmetic unit 120 stores the dynamic image for the left eye and the new dynamic image for the right eye as the stereoscopic moving picture in the storage unit 130. The dynamic image for the left eye, which is stored herein, may also be referred to as a new dynamic image for the left eye.

Moreover, in the description give above, the new image is obtained by moving one whole image in parallel. Herein, the arithmetic unit 120 may move in parallel the whole images of the dynamic images by a quantity that is ½ of the offset quantity with respect to the individual dynamic images (the dynamic image for the left eye, the dynamic image for the right eye). Further, the arithmetic unit 120 may also move in parallel the whole image of the dynamic image by a quantity that is ⅓ of the offset quantity with respect to one dynamic image, and may move in parallel the whole image of the dynamic image by a quantity that is ⅔ of the offset quantity with respect to the other dynamic image. A ratio to the offset quantity on the occasion of the parallel movement can be set without any restrictions. It is, however, required that each of the quantities of the parallel movements in the dynamic image for the left eye and the dynamic image for the right eye is coincident with the offset quantity on the whole. At this time, it follows that the arithmetic unit 120 generates the new dynamic image for the left eye and the new dynamic image for the right eye and stores the generated images in the storage unit 130.

The stored dynamic images for the left and right eyes can be displayed on the display device for the stereoscopic view. The display device for the stereoscopic view is such a type of a display device that the dynamic image for the left eye is inputted to the left eye, while the dynamic image for the right eye is inputted to the right eye. Moreover, the stored dynamic images for the left and right eyes may also be displayed on the display unit 140.

In step S103, the images of the dynamic images at all of the timings are processed based on the offset quantities (ΔX0 and ΔY0) acquired in step S102.

The dynamic image for the left eye and the dynamic image for the right eye, which are processed in step S103, are employed in the subsequent processes. The process of making the parallel movement to the degree corresponding to the offset quantity in step S103 may be done on the image-by-image basis in step S104.

In step S104, the arithmetic unit 120 takes out the images (the image for the left eye and the image for the right eye) at the timing next to the images processed just previously from the storage unit 130. The taken-out images for the left and right eyes have already been processed based on the offset quantity acquired in step S102. The arithmetic unit 120 determines, from the image (the image processed in immediate previous step S103 or immediate previous step S104) processed just previously and the image at the timing next to this image, which object moves within the picture (FIG. 8: S104). That is, the arithmetic unit 120 determines, based on the image for the left eye that is processed just previously and the image for the left eye at the timing next to this image, which object moves or does not move. Further, the arithmetic unit 120 determines, based on the image for the right eye that is processed just previously and the image for the right eye at the timing next to this image, which object moves or does not move.

To be specific, the arithmetic unit 120 determines, e.g., which object moves or does not move by determining whether or not the moving image (region) exists in the data of the image at the timing next to the image processed just previously. The moving image (region) is the image containing the moving physical object (object) etc. If the moving image (region) does not exist, none of the moving portion exists within the picture. Hence, the moving image (region) does not exist, in which case it is considered that any objects within the picture do not move. Moreover, if the moving image exists, the arithmetic unit 120 determines that any one of the objects moves.

Furthermore, the arithmetic unit 120 takes, e.g., a difference of each pixel between the image processed just previously and the image at the next timing, and may determine which object moves or does not move on the basis of whether or not there exits the region with the difference not being “0”. The region with the difference not being “0” is the image containing the moving physical object (object) etc. The arithmetic unit 120 may set the region with the difference not being “0” on the image processed just previously as the image of the moving physical object. If the region with the difference not being “0” does not exist, there is no portion moving within the picture. Hence, if the region with the difference not being “0” does not exist, it is considered that any objects within the picture do not move. Moreover, if the region with the difference not being “0” exists, the arithmetic unit 120 determines that any one of the objects moves.

If it is determined that any one of the objects moves (S104; YES), the arithmetic unit 120 extracts the physical objects (objects) that are common within the two moving images with respect to the image for the left eye and the image for the right eye, which are taken out in step S104 (S105). Further, if the moving images exist within only one image (the image for the left eye or the image for the right eye), the arithmetic unit 120 extracts the physical objects (objects) that are common to the moving image and the image with the moving image not existing. These common objects are defined as the moving objects. The extraction of the common objects involves using, e.g., pattern matching. The arithmetic unit 120 stores, in the storage unit 130, the positions of the respective images (the image for the left eye and the image for the right eye) of the common physical object (moving objects). Moreover, the arithmetic unit 120 stores the images of the common objects in the storage unit 130.

The pattern matching is executed, e.g., as follows. The arithmetic unit 120 superposes the moving image in the image for the left eye on the moving image in the image for the right eye in a certain position, and takes a difference between the pixel values in the superposed region. The arithmetic unit 120 obtains a position and a size of an area with the difference being “0” in the superposed region. The position of this area can be set to a central position of the region of each image. Further, the arithmetic unit 120 similarly takes the difference of the superposed region in each of the positions by arbitrarily moving the superposed position in parallel, and obtains the position and the size of the area with the difference being “0” in the superposed region. The arithmetic unit 120 extracts the area having the largest size with the difference being “0”. The arithmetic unit 120 can deem the area having the largest size with the difference being “0” (the area with the difference being “0”) as the moving object (the common physical object) and the position of the area (the area with the difference being “0”) as the position of the moving object. This area (region) can be considered to be the same object in the same form in the image for the left eye and the image for the right eye. Note that the pattern matching method is not limited to the method described above, but other known methods are applicable. These common physical objects (the moving objects) are recognized by the user who views the stereoscopic moving picture as the same object in the stereoscopic moving picture.

Herein, the images (which are referred to as predetermined images) of the common physical objects may be stored beforehand in the storage unit 130. At this time, the arithmetic unit 120 may extract the common physical objects by performing the pattern matching of the image for the left eye and the image for the right eye with the predetermined images stored in the storage unit 130. Moreover, the images of the once-extracted common physical objects may also be stored as the predetermined images in the storage unit 130.

In step S106, the arithmetic unit 120 calculates the parallax quantity between the moving objects (S106). The arithmetic unit 120 calculates differences between the positions of the moving object in the image for the left eye and the positions of the moving object in the image for the right eye, which are acquired in step S105. The thus-obtained differences become the parallax quantities herein. In these obtained differences, the difference in the crosswise direction is set as a parallax quantity ΔX1, and the difference in the lengthwise direction is set as a parallax quantity ΔY1. The arithmetic unit 120 stores the parallax quantity ΔX1 in the crosswise direction and the parallax quantity ΔY1 in the lengthwise direction in the storage unit 130. Initial values of the parallax quantity ΔX1 and the parallax quantity ΔY1 are both “0”.

The arithmetic unit 120 determines whether or not a magnitude of the parallax quantity calculated in step S106 is smaller than a predetermined value (S107). A magnitude A of the parallax quantity is expressed by the following formula.

A=\sqrt{ΔX1²+ΔY1²} [Mathematical Expression 2]

The arithmetic unit 120 determines whether the magnitude A of the parallax quantity is smaller than the predetermined value or not. The predetermined value is previously stored in the storage unit 130. The arithmetic unit 120 properly fetches this predetermined value from the storage unit 130. The predetermined value is settled based on whether or not the user viewing the stereoscopic moving picture can recognize the common physical objects displayed in the image for the left eye and the image for the right eye as the same object. The predetermined quantity can be set to, e.g., a 3% quantity of a breadth of the image (the image for the left eye or the image for the right eye). If the magnitude of the parallax quantity of the common physical object displayed in the image for the left eye and the image for the right eye is within 3% of the breadth of the image, the user can recognize the common physical object displayed in the image for the left eye and the image for the right eye as the same physical object. The predetermined quantity is not limited to the 3% of the breadth of the image but may take other values. The image assumed herein is an image of which an aspect ratio is approximately 16:9. Accordingly, if being the image of which the aspect ratio deviates from this ratio (16:9), the predetermined value could become larger or smaller than 3% of the breadth of the image. Moreover, the predetermined value may also be a ratio to a vertical width of the image. If the magnitude A of the parallax quantity is smaller than the predetermined value, the user can recognize the common physical object displayed in the image for the left eye and the image for the right eye as the same object. Whereas if the magnitude A of the parallax quantity is equal to or larger than the predetermined value, the user might be unable to recognize the common physical object displayed in the image for the left eye and the image for the right eye as the same object.

If the magnitude of the parallax quantity is equal to or larger than the predetermined value (S107; YES), the arithmetic unit 120 newly generates the image for the right eye (S108). The arithmetic unit 120 generates a new image for the right eye from the non-moving image in the image for the right eye that is processed just previously in step S104, the moving object in the image for the left eye that is processed in step S104 and the parallax quantity in the immediate previous image. That is, the arithmetic unit 120 generates the new image for the right eye by superposing the moving object in the image for the left eye that is processed in step S104 on the non-moving image in the image for the right eye that is processed just previously. The position for the superposition is a position which moves in parallel to the degree corresponding to the parallax quantity of the moving object in the image processed just previously from the position, in the image for the left eye, of the moving object in the image for the left eye that is processed in step S104. The arithmetic unit 120 may newly generate the image for the left eye in place of the image for the right eye. Further, the arithmetic unit 120 calculates moving quantities of the common physical object, and may set the image (the image for the left eye or the image for the right eye) exhibiting the larger moving quantity as an image to be newly generated. Conversely, the arithmetic unit 120 calculates the moving quantities of the common physical object, and may set the image (the image for the left eye or the image for the right eye) exhibiting the smaller moving quantity as the image to be newly generated. The moving quantity of the common physical object is calculated based on a difference between the image processed just previously in step S104 and the position of the moving object in the image at the next timing.

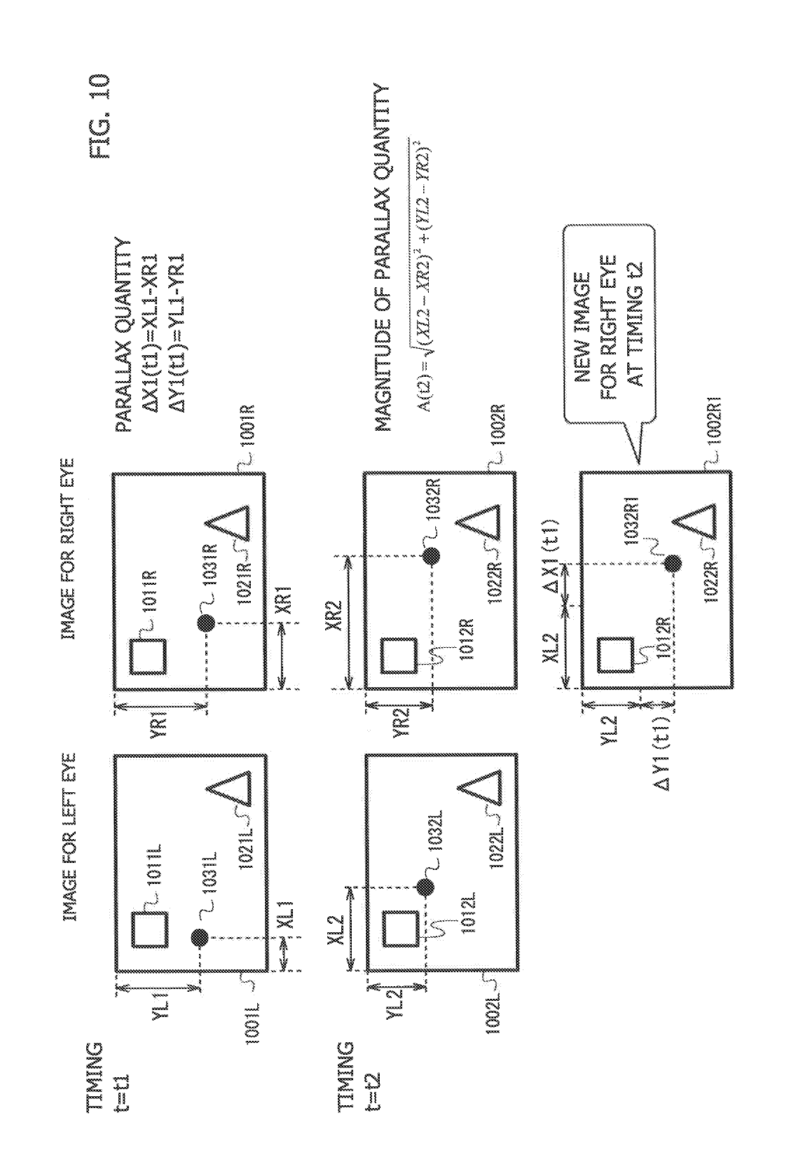

FIG. 10 is an explanatory diagram of step S108. FIG. 10 depict an image 1001L for the left eye and an image 1001R for the right eye at the timing t=t1, an image 1002L for the left eye and an image 1002R for the right eye at the timing t=t2, and a new image 1002R1 for the right eye. The images at the timing t1 are images just previous to the images at the timing t2. Herein, a physical object 1011L, a physical object 1011R, a physical object 1012L and a physical object 1012R are defined as the same non-moving physical object. Similarly, a physical object 1021L, a physical object 1021R, a physical object 1022L and a physical object 1022R are defined as the same non-moving physical object. These non-moving physical objects exist in the non-moving images of the respective images (the image 1001L for the left eye and so on). Moreover, a physical object 1031L, a physical object 1031R, a physical object 1032L and a physical object 1032R are defined as the same moving physical object. These moving physical objects exist in the moving images of the respective images (the image 1001L for the left eye and so on).

Let (XL1, YL1) be a position of the moving physical object 1031L in the image 1001L for the left eye at the timing t1 and (XR1, YR1) be a position of the physical object 1031R in the image 1001R for the right eye. The parallax quantities of this moving physical object are acquired as follows.

ΔX1(t1)=XL1−XR1

ΔY1(t1)=YL1−YR1 [Mathematical Expression 3]

Similarly, let (XL2, YL2) be a position of the moving physical object 1032L in the image 1002L for the left eye at the timing t2 and (XR2, YR2) be a position of the physical object 1032R in the image 1002R for the right eye. The parallax quantities of this moving physical object are acquired as follows.

ΔX1(t2)=XL2−XR2

ΔY1(t2)=YL2−YR2 [Mathematical Expression 4]

Furthermore, a magnitude A(t2) of the parallax quantity of the moving physical object 1032 (the physical objects 1032L and 1032R) at the timing t2 is obtained from this mathematical expression 4 as follows.

$$\begin{matrix}A ( t 2 ) = \sqrt{Δ X 1 {( t 2 )}^{2} + Δ Y 1 {( t 2 )}^{2}} \\ = \sqrt{{( XL 2 - XR 2 )}^{2} + {( YL 2 - YR 2 )}^{2}}\end{matrix} \qquad [ Mathematical Expression 5 ]$$

Herein, if a magnitude A(t2) of the parallax quantity is equal to or larger than the predetermined value, the arithmetic unit 120 newly generates the image for the right eye. The arithmetic unit 120 generates the new image for the right eye from the non-moving image in the image 1001R for the right eye at the timing t1, the moving physical object 1032L in the image for the left eye at the timing t2, and the parallax quantity of the physical object 1031 (the physical object 1031L and the physical object 1031R) at the timing t1. To be specific, the arithmetic unit 120 generates the new image 1002R1 for the right eye by superposing the moving object 1032L in the image for the left eye at the timing t2 on the non-moving image in the image 1001R for the right eye at the timing t1. The position for the superposition is a position which moves in parallel to a degree corresponding to parallax quantities (ΔX1(t1) and ΔY1(t1)) of the moving physical object 1031 (the physical object 1031L and the physical object 1031R) at the timing t1 from a position (XL1, YL2) of the moving physical object 1032L in the image for the left eye at the timing t2. The position of the post-moving physical object 1032 in the image for the right eye at the timing t2 is a position of the physical object 1032R1 in the new image 1002R1 for the right eye. Further, herein, the arithmetic unit 120 deems the magnitude A(t2) of the parallax quantity to be A(t1) and stores this magnitude in the storage unit 130. This magnitude A(t2) (=A(t1)) of the parallax quantity is a magnitude of the parallax quantity between the position of the moving physical object in the image for the left eye at the timing t2 and the position of the moving physical object in the new image for the right eye.

Referring back to FIG. 8, if it is determined that any one of the objects does not move (S104; NO) or if the magnitude of the parallax quantity is smaller than the predetermined value (S107; YES), the processing advances to step S109.

In step S109, the arithmetic unit 120 generates the stereoscopic moving picture (S109). The arithmetic unit 120 organizes the image for the left eye and the image for the right eye, which are extracted in step S104, into one set (one set of frames) of images of the stereoscopic moving picture and stores these images in the storage unit 130 in the way of being associated with the timing information processed in step S104. The arithmetic unit 120, in the case of generating the image for the right eye (or the image for the left eye) in step S108, sets this image as the image for the right eye (or the image for the left eye).

In step S110, the arithmetic unit 120 checks whether or not there exists the image having the timing of the timing information next to the timing of the timing information of the image processed in step S104. Namely, the arithmetic unit 120 determines whether the image processed in step S104 is the last image or not (S110). If the image processed in step S104 is the last image (S110; YES), the arithmetic unit 120 finishes the processing. Whereas if the image processed in step S104 is not the last image (S110; NO), the arithmetic unit 120 loops the processing back to step S104.

### Operation, Effects of the Embodiment

The stereoscopic moving picture generating apparatus 100 calculates the parallax quantity between the image for the left eye and the image for the right eye of the moving object. The stereoscopic moving picture generating apparatus 100, if the magnitude of the calculated parallax quantity is not smaller than the predetermined value, generates the new image on the basis of the image processed just previously, the parallax quantity in the image processed just previously and the moving object.

The stereoscopic moving picture generating apparatus 100, if such a possibility exists that the objects common to the image for the left eye and the image for the right eye is not recognized as the same object due to abnormality etc in the image processing, generates the new images. The stereoscopic moving picture generating apparatus 100 can generate the stereoscopic moving picture with no sense of incongruity in which the common objects can be recognized as the same object.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A stereoscopic moving picture generating apparatus comprising:
a storage unit to get stored with a first dynamic image containing a plurality of images associated with respective items of timing information, a second dynamic image containing the plurality of images associated with the respective items of timing information, a predetermined image and a predetermined value; and
an arithmetic unit to calculate a first difference quantity defined as a difference between a first position and a second position by extracting a first image of the first dynamic image and a second image of the second dynamic image which are associated with first timing information and the predetermined image from the storage unit, calculating the first position defined as an existing position of the predetermined image in the first image and calculating the second position defined as an existing position of the predetermined image in the second image; to calculate a second difference quantity defined as a difference between a third position and a fourth position by extracting a third image of the first dynamic image and a fourth image of the second dynamic image which are associated with second timing information defined as a timing next to the first timing information with respect to the first dynamic image and the predetermined value from the storage unit, calculating the third position defined as an existing position of the predetermined image in the third image and calculating the fourth position defined as an existing position of the predetermined image in the fourth image; and to generate, when a magnitude of the second difference quantity is equal to or larger than the predetermined value, a new fourth image on the basis of the second image, the third image and the first difference quantity.

2. The stereoscopic moving picture generating apparatus according to claim 1, wherein the predetermined image is an image in a region where a difference between the first image and the third image is not “0” on the first image, or an image in a region where a difference between the second image and the fourth image is not “0” on the second image.

3. The stereoscopic moving picture generating apparatus according to claim 1, wherein the predetermined value is set to a magnitude of a predetermined ratio to a breadth of the first image.

4. A stereoscopic moving picture generating method by which a computer executes:
calculating a first difference quantity defined as a difference between a first position and a second position by extracting a first image of the first dynamic image and a second image of the second dynamic image which are associated with first timing information and a predetermined image from a storage device stored with a first dynamic image containing a plurality of images associated with respective items of timing information, a second dynamic image containing the plurality of images associated with the respective items of timing information, the predetermined image and a predetermined value, calculating the first position defined as an existing position of the predetermined image in the first image and calculating the second position defined as an existing position of the predetermined image in the second image;
calculating a second difference quantity defined as a difference between a third position and a fourth position by extracting a third image of the first dynamic image and a fourth image of the second dynamic image which are associated with second timing information defined as a timing next to the first timing information with respect to the first dynamic image and the predetermined value from the storage device, calculating the third position defined as an existing position of the predetermined image in the third image and calculating the fourth position defined as an existing position of the predetermined image in the fourth image; and
generating, when a magnitude of the second difference quantity is equal to or larger than the predetermined value, a new fourth image on the basis of the second image, the third image and the first difference quantity.

5. The stereoscopic moving picture generating method according to claim 4, wherein the predetermined image is an image in a region where a difference between the first image and the third image is not “0” on the first image, or an image in a region where a difference between the second image and the fourth image is not “0” on the second image.

6. The stereoscopic moving picture generating method according to claim 4, wherein the predetermined value is set to a magnitude of a predetermined ratio to a breadth of the first image.

7. The non-transitory computer readable storage medium storing a stereoscopic moving picture generating program for a computer to execute:
calculating a first difference quantity defined as a difference between a first position and a second position by extracting a first image of the first dynamic image and a second image of the second dynamic image which are associated with first timing information and a predetermined image from a storage device stored with a first dynamic image containing a plurality of images associated with respective items of timing information, a second dynamic image containing the plurality of images associated with the respective items of timing information, the predetermined image and a predetermined value, calculating the first position defined as an existing position of the predetermined image in the first image and calculating the second position defined as an existing position of the predetermined image in the second image;
calculating a second difference quantity defined as a difference between a third position and a fourth position by extracting a third image of the first dynamic image and a fourth image of the second dynamic image which are associated with second timing information defined as a timing next to the first timing information with respect to the first dynamic image and the predetermined value from the storage device, calculating the third position defined as an existing position of the predetermined image in the third image and calculating the fourth position defined as an existing position of the predetermined image in the fourth image; and
generating, when a magnitude of the second difference quantity is equal to or larger than the predetermined value, a new fourth image on the basis of the second image, the third image and the first difference quantity.

8. The non-transitory computer readable storage medium storing a stereoscopic moving picture generating program according to claim 7, wherein the predetermined image is an image in a region where a difference between the first image and the third image is not “0” on the first image, or an image in a region where a difference between the second image and the fourth image is not “0” on the second image.

9. The non-transitory computer readable storage medium storing a stereoscopic moving picture generating program according to claim 7, wherein the predetermined value is set to a magnitude of a predetermined ratio to a breadth of the first image.
